(19) United States
(12) Patent Application Publication
(10) Pub. No.: US 2002/0110250 A1
(43) Pub. Date: Aug. 15, 2002

(54) Miniature microphone with improved wind protection

(76) Inventor: Christoph Schwald, Wien (AT)

Correspondence Address: FRIEDRICH KUEFFNER, SUITE 1921, 342 MADISON AVENUE, NEW YORK, NY, 10173, US

(21) Appl. No.: 10/077,185

(22) Filed: Feb. 15, 2002

(30) Foreign Application Priority Data
Feb. 15, 2001 (AU) A 240/2001

(51) Int. Cl. H04R 1/02; H04R 9/08

(52) U.S. Cl. 381/91; 381/355

(57) ABSTRACT

A miniature microphone includes a microphone button or capsule mounted in a microphone housing, wherein the microphone housing has front sound entry openings in communication with a front volume and rear sound entry openings in communication with a rear volume, and wherein the front volume is in communication with front sound entry openings of the microphone capsule and the rear volume is in communication with rear sound entry openings of the microphone capsule. A connecting volume is provided between the front volume and the rear volume.

### BACKGROUND OF THE INVENTION

1. Field of the Invention

The present invention relates to a miniature microphone with a microphone button or capsule mounted in a microphone housing, wherein the microphone capsule has front sound entry openings which lead to a front volume, rear sound entry openings which lead to a rear volume, and a connecting volume; specifically, the invention relates to a pressure-gradient microphone with improved wind protection or pop protection.

2. Description of the Related Art

Independently of their physical manner of operation, microphone capsules can be constructed as pressure microphones or pressure-gradient microphones. The two types of capsules differ from each other primarily with respect to the pickup pattern which can be achieved. The pickup pattern of a microphone capsule is defined as the sensitivity of the capsule in dependence on the angle of incidence, and can be described as a spherical, cardioid, hypercardioid, supercardioid, or figure-eight pickup pattern with corresponding polar diagram. Pressure microphones in which the diaphragm of the capsule is excited only from one side have a spherical pickup pattern.

In order to be able to achieve a one-sided pickup pattern, so called pressure-gradient microphones must be constructed. These microphones not only have a front entry opening, but also a second sound entry opening which may be provided on the side or in the rear and serves to subject the diaphragm of the microphone capsule to a pressure difference. The acoustic tuning of a pressure-gradient capsule is carried out by an expert using conventional acoustic means, so that the desired pickup pattern as well as a desired frequency pattern are achieved.

Although microphone capsules with a pronounced one-sided pickup pattern are in demand because of their wind noise-insulating properties, compared to capsules with spherical pickup patterns they also have a significant disadvantage with respect to wind or so called pop noises. Pop noises are produced by unskilled pronunciation of explosive consonants, such as “P” or “B”.

In accordance with the conventional prior art, damping of the wind noises is effected by means of various types of microphone screens. The microphone screens which also serve as mechanical protection of the microphone capsule, are filled with various porous materials. Primarily used for this purpose are open-pore foam materials which are either placed into the interior of the microphone screen grating, or are placed as wind protection blankets onto the microphone blanket grating. The effectiveness of such wind protection devices depends on the density of the foam, on the one hand, and on the distance to the microphone capsule, on the other hand. A denser foam material generally produces a better wind protection, but also results in a sensitivity loss of the microphone at higher frequencies. The situation is similar with respect to the distance from the microphone capsule to be protected. A greater distance means better protection, however, with the disadvantage that the microphone can no longer be constructed so small so as to be unnoticeable.

An example for the use of protective devices against popping based on foam material is EP 0 130 400 A2. This pop and wind protection is manufactured of open-pore foam material and is placed around the microphone housing.

Another method is described in U.S. Pat. No. 4,966,252. In this case, not only the capsule area of the microphone, but the entire microphone is mounted in a zeppelin-like wind protection housing.

DE 298 13 397 U1 also describes a wind protection on the basis of foam material which is placed around the microphone housing.

All three examples have in common that their construction is complicated and expensive and that external climatic conditions have a very negative influence on the service life of the protective devices.

Miniature microphones which are primarily carried on the human body, either by being snapped on, pinned on, glued on or placed on the human body, are constructed as pressure microphones for the purpose of reducing the wind or pop sensitivity. This makes it possible to keep the wind sensitivity of the microphone low, but because of the spherical pickup pattern of the microphone undesirable noises from the acoustic surrounding of the microphone are received and further transmitted. Up to now, the use of miniature microphones with unilateral pickup patterns was made especially difficult because of their sensitivity to wind. They always absolutely had to have an outer protective blanket of foam material.

### SUMMARY OF THE INVENTION

Therefore, it is the primary object of the present invention to make it possible to integrate miniature microphones which are composed of dynamic or electret capsules with one-sided pickup patterns having small dimensions (for example, microphone arm of a head set) with the special feature of an integrated wind protection without making the structure of the microphone complicated and expensive.

In accordance with the present invention, this object is met in the mounted state of the microphone capsule by means of narrow ducts which are provided in the interior of the microphone housing and effect an acoustic connection between the front and rear sides of the microphone capsule.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 and FIG. 2 are schematic illustrations for explaining the problems on which the invention is based;

FIG. 3 is a cross-sectional view of a small microphone according the prior art;

FIG. 4 is a cross-sectional view of a microphone according to the present invention; and

FIG. 5 is a sectional view taken along sectional line V-V of FIG. 4.

### DESCRIPTION OF THE PREFERRED EMBODIMENTS

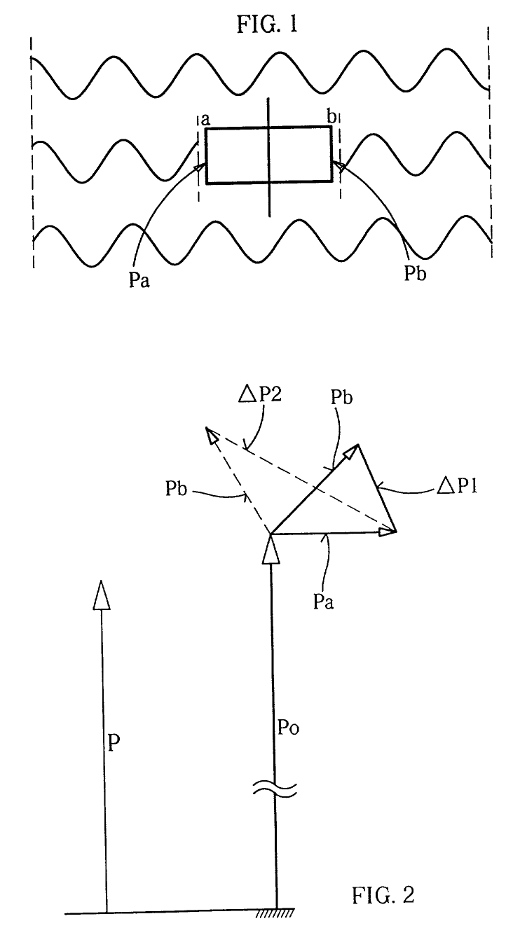

The problems on which the present invention is based will be discussed in the following in connection with FIGS. 1 and 2. FIG. 1 shows a turbulent sound field, illustrated by wavy lines, and a microphone capsule with two sound entry openings a and b in the sound field.

FIG. 2 illustrates with the aid of a vector diagram the pressure conditions in a turbulent sound pressure field. The individual vectors have the following meaning: PO is the static air pressure whose intensity changes are so slow that they are negligible. Two vectors Pa and Pb are shown at the tip of the vector PO. The length of the vector PO is longer than the length of the two vectors Pa and Pb by the factor 10⁵ (100,000). The two vectors Pa and Pb represent the sound pressure conditions at the locations of the two sound entry openings a and b of the microphone capsule illustrated in FIG. 1. Since the microphone capsule is small, the intensities or lengths of the two vectors Pa and Pb is identical (they are not weakened over such a short length). However, their phase positions are completely random because of the turbulence of the sound field. Two situations are illustrated in FIG. 2. In the first case, shown in solid lines, the vector Pb has a phase angle of about 45°, and the vector difference which acts as the driving force on the diaphragm of the microphone capsule, has an intensity of ΔP1. At another point in time, shown in broken lines, the vector Pb has a phase angle of about 120°. In that case, the pressure difference Pa−Pb=ΔPs is greater than the individual pressures Pa or Pb.

This means that in a turbulent air pressure surrounding, as it usually exists when wind or pop noises occur, the diaphragm driving force is significantly greater in a pressure-gradient capsule than in a pressure capsule. This is because in a turbulent air pressure field the pressure differences between two adjacent points can become significantly greater than the air pressure at one point in the same turbulent air pressure field over time, as can be seen in FIG. 2. The microphones which are constructed with such microphone capsules are particularly sensitive to wind noises and the reduction of the wind noises is normally very difficult to achieve.

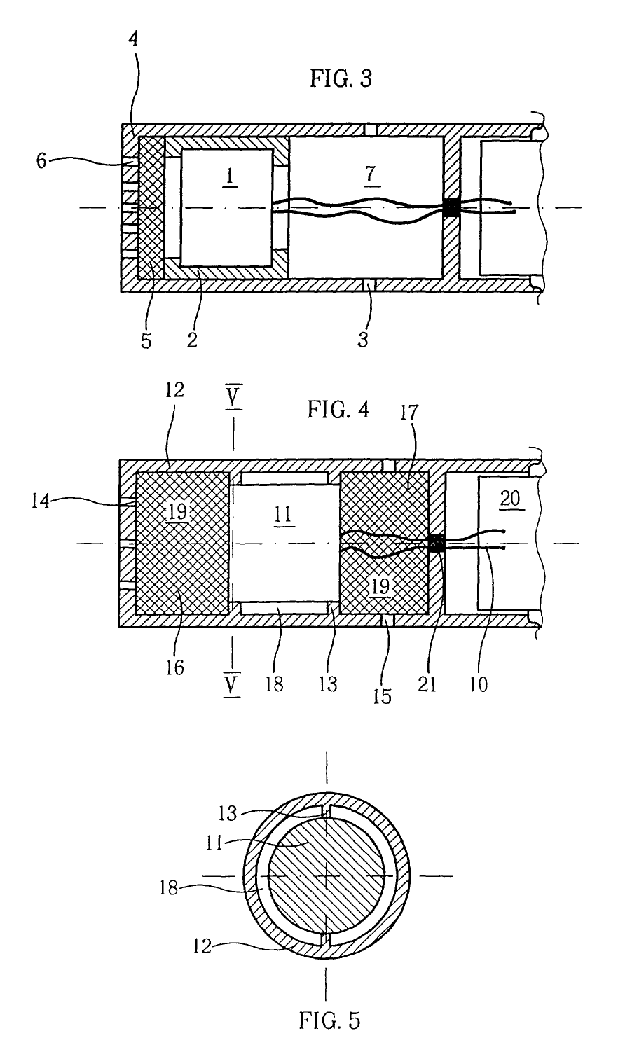

FIG. 3 shows a conventional small microphone with one-sided pickup pattern in accordance with the prior art. The microphone capsule 1 provided with a front and a rear sound entry opening, not shown, is embedded in an elastic hollow-cylindrical capsule support 2 which dampens grasping or frictional noises. Lateral sound openings 3 are integrated in the microphone housing 4, wherein the openings lead to a rear volume 7. A more or less porous foam material 5 is usually placed on the front capsule side in the front volume which has corresponding front sound entry openings 6 in the microphone housing 4. The purpose of the porous foam material 5 is twofold. First, the foam material provides a dust protection of the capsule; second, it is desired to achieve a pop protection.

It can be seen in the illustrated solution that the microphone capsule 1 constructed as a pressure-gradient microphone has two sound entry openings, not shown, while no foam material is placed in the rear volume 7 with the rear sound entry openings 3, and that the capsule support 2 acoustically completely insulates the front volume from the rear volume. This reduces the manufacturing costs significantly, however, the wind sensitivity of the microphone is further increased because only completely equal sound paths do not lead to additional pressure differences at the diaphragm of the capsule.

The lack of the foam material in the rear volume 7 of the microphone increases the pressure differences in the diaphragm (as compared to the complete lack of foam material covers) and, thus, the wind or pop sensitivity is also increased.

Consequently, it is necessary to provide conventional microphone components with small dimensions (external diameter of up to 25 mm) for protection against wind noises or pop noises with an additional foam material body (wind protection component) which is pulled or placed over the entire structure. The disadvantages of this configuration are the additional space requirement as well as the fact that these so called additional wind protection components age as a result of ambient influences.

The solution according to the present invention is illustrated in FIGS. 4 and 5. A conventional pressure-gradient capsule 11 with one-sided pickup pattern is placed in a—usually cylindrical—housing 12 which, however, can also be shaped differently, and the capsule 11 is supported by knobs or webs 13 which project inwardly from the housing wall. Provided in the housing 12 are front sound entry openings 14 and rear sound entry openings 15. The capsule 11 placed in the housing 12 forms in the housing 12 a front volume 16, a rear volume 17 and a connecting volume 18 which connects the volumes 16 and 17.

The front volume 16 and the rear volume 17 are each partially or totally filled with at least one sound-permeable foam component 19. The connecting volume 18 serves as a smoothing zone and together with the properties of the foam components 19 results in a very strong damping of the wind noises. The front sound entry openings 14 allow the sound to enter from the front into the front volume 16 and, thus, to the entry openings on the front side of the capsule 11, not shown, as well as through the connecting volume 18 to the rear volume 17 and from there to the rear sound entry openings, not shown, on the rear side of the capsule 11.

The rear wall of the rear volume 17 is acoustically tightly insulated from the following structure because the volume 17 is very small, on the one hand, and because the microphone housing 12 is closed on the inside and does not permit coupling to other volumina. FIG. 4 also shows the connecting wires on capsule 11. The wires are pulled through an opening and the opening is closed by means of an adhesive or another elastic material 21 so that the remaining volume 20 of the microphone housing is not acoustically coupled to the volume 17.

The sizes of the volumina and the entry openings are selected by applying the criteria usually used in the construction of microphones in such a way that the desired formation of the frequency pattern is achieved. The shape and size of the front volume 16, which is preferably entirely filled with foam material 19, is preferably selected in such a way that its height (distance between the front side of the microphone capsule 11 and the front sound entry openings 14) is about ¼ of the smallest wave length to be transmitted (highest frequency to be transmitted). This utilizes the effect of the volume as a resonator and spreads out the microphone frequency pattern in the case of higher frequencies. The size of the rear volume 17 is less critical as long as the openings 15 are arranged close enough to the bottom of the capsule 11, on the one hand, and its size permits an unrestricted sound passage. The connecting ducts which are illustrated as connecting volume 18 have preferably a width of 0.5 to 2 mm in the radial direction. The ducts can also have a greater width, however, this only makes sense in exceptional cases because this once again increases the size of the microphone.

Finally, it should be pointed out that in the specification and claims the term “volume” refers to a volume which is empty or filled partially or totally with foam material or the like, wherein, however, the volume is always acoustically substantially permeable.

The invention is not limited by the embodiments described above which are presented as examples only but can be modified in various ways within the scope of protection defined by the appended patent claims.

I claim:

1. A miniature microphone comprising
a microphone housing;
a microphone capsule mounted in the microphone housing; wherein
the microphone housing has front sound entry openings in communication with a front volume and rear sound entry openings in communication with a rear volume, wherein the front volume is in communication with front sound entry openings of the microphone capsule and the rear volume is in communication with rear sound entry openings of the microphone capsule; further comprising
a connecting volume connecting the front volume and the rear volume.

2. The miniature microphone according to claim 1, wherein the connecting volume is comprised of narrow ducts.

3. The miniature microphone according to claim 1, wherein the front volume and the rear volume are each totally or partially filled with at least one sound-permeable foam component.

4. The miniature microphone according to claim 1, wherein the connecting volume is comprised essentially of an annular gap between an inner side of a wall of the housing and an outer side of the microphone capsule.

5. The miniature microphone according to claim 1, wherein the housing has knobs or webs for supporting the microphone capsule.

6. The miniature microphone according to claim 1, wherein the front volume has a height equal to about ¼ of the smallest wave length to be transmitted.
